(19) United States
(12) Patent Application Publication
(10) Pub. No.: US 2023/0080560 A1
(43) Pub. Date: Mar. 16, 2023

(54) Method of manufacturing seamless three-dimensional decorative elements from natural non-spun wool fibers and mounting method

(71) Applicants: Alla Borovskaia, Ellicott CIty, MD (US); Milana Borovskaia, Ellicott City, MD (US)

(72) Inventors: Alla Borovskaia, Ellicott CIty, MD (US); Milana Borovskaia, Ellicott City, MD (US)

(21) Appl. No.: 17/300,663

(22) Filed: Sep. 16, 2021

(51) Int. Cl. B44C 1/10

(52) U.S. Cl. CPC B44C 1/10

(57) ABSTRACT

Result of the successive steps described in this invention: light, durable, decorative elements having a stable three-dimensional shape are obtained. The mounting method is in such a way as not to damage the surface.

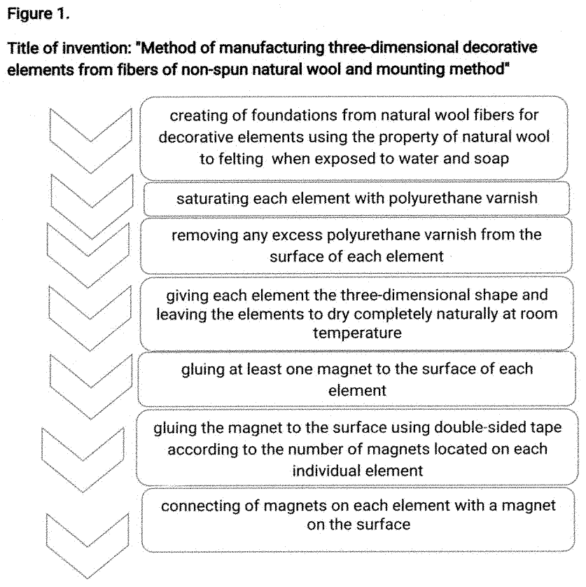

The manufacturing method described in this invention implies do not use ready-made material, but create each product by hand puling out very small strands of natural organic fibers of fine wool, a layer-by-layer application to the template/mold takes place and a further multistage process of forming the product.

Then polyurethane varnish is applied in accordance with a specific technology disclosed in this invention and each individual element is formed, then leaving the elements to dry completely naturally at room temperature;

After each element is dry and three-dimensional stable, need gluing at least one magnet to the surface of each element, also need gluing the magnet to the surface using double-sided tape according to the number of magnets located on each individual element and last step to connecting of magnets on each element with a magnet on the surface;

Decorative elements created according to the method of this invention do not need a rigid base and have good adhesion to the wall without drilling holes in the wall.

These elements are intended for decoration of interior surfaces, in particular, but not exclusively walls, in order to decorate the interior and improve the emotional wellbeing of people of all ages. Despite the stable three-dimensional shape, these decorative elements are safe to use, because they are easily to attach without any secondary skills and safely, injury is excluded when the decorative element falls because they are lightweight and do not have hardness that can cause harm in the event of fall, this makes a high level of safety.

Natural wool is a difficult material to produce sculpted three-dimensional shapes that can be attached to a wall. A common practice of natural wool fibers is to two-dimensional art or suspended three-dimensional objects not represent attached to a wall. Therefore, the technology of creating decorative elements from natural non-spun wool fiber is a new level of development of the decor of working with natural wool fibers.

At the first stage, a light-weight non-woven seamless foundations from natural wool fibers for decorative elements is manually created from non-spun natural woof fibers.

Natural non-spun wool fibers up to 21 microns must be used and can be presented in various forms.

Further, there is a fine layout of the wool fibers, strand by strand, onto the template.

The layout of the fibers of the non-spun wool can also be done in various ways, for example, parallel perpendicularly or randomly overlapping the strands, this invention implies the freedom in choosing the method of laying the fibers on the template.

The dimensions and size of the foundations from natural wool fibers for each of the decorative elements may vary depending on the idea.

This is followed by a process based on the morphological characteristics of the non-spun natural wool fibers.

The fiber's layout on the template then irrigated with a soap and water solution, it is preferable to use transparent soap in the ratio of the proportion of soap and water depends on the type of wool fiber and the optimal finding of the ratio is found by creating an experimental sample.

Poured wool fibers with soapy water, are covered with a film with pimples over the film with pimples also a soapy solution is applied and friction is performed by hand with arbitrary movements so that the wool fibers adhere to each other.

The future foundations from natural wool fibers for decorative elements is wrapping in a roll and a mechanical action is performed sequentially by alternating friction and twisting then the roll is unrolled, next need to dip in hot water and again all over again wrapping in a roll and make friction and twisting.

These actions are performed alternately until the foundations from natural wool fibers for decorative elements is ready and acquires a two-dimensional shape.

This method of creating a foundations from natural wool fibers for future decorative elements described above in this invention will be understood by a person skilled having experience in working in the field of creating felt from non-spun wool fibers by the type of wet wool felting.

As a result, the wool is combined into a monolithic structure and seamless foundations from natural wool fibers for decorative elements is obtained.

After the foundations from natural wool fibers for decorative elements is ready, it must be wetted with varnish polyurethane (Maybe, both glossy and matte, it is preferable to use polyurethane varnish from the company DecoArt Americana DuraClear) and completely soaked, then thoroughly squeezed and remove excess.

Depending on the desired effect, you can use different concentrations and change

concentration of polyurethane varnish because he perfectly interact with water in order to reduce the concentration and when creating a sample you can see the effect of varnish on the future decorative element in different varnish concentrations.

At the next stage, each decorative element is given a three-dimensional shape and is left to dry until completely dry.

After drying, the polyurethane varnish becomes completely invisible, and no visual external traces remain, as a result each individual decorative element acquires a stable three-dimensional shape, keeping the lightness and surface inherent in natural wool fibers.

Mounting Method:

Elements created according to the above method have good adhesion.

Gluing at least one magnet to the surface of each element.

The choice of magnet is not limited in the present invention, but must be suitable and have sufficient strength. And also, the size and number of magnets can vary depending on the size of each individual element (for example, can be using Super Strong Neodymium Disc Magnets).

Any suitable adhesive can be used to attach the magnet to the surface of each element (e.g. Gorilla Super Glue Gel).

Gluing the magnet to the surface using double-sided tape according to the number of magnets located on each individual element. To do this, can using different types of double-sided tape (for example, transparent/clear double-sided tape or foam double-sided tape).

Connecting of magnets on each element with a magnet on the surface.

While the disclosed subject has been described in conjunction with a number of embodiment, it is evident that many alternatives, modifications and variations would be, or are, apparent to those of ordinary skill in the applicable arts. Accordingly, applicant intends to embrace all such alternatives, modifications, equivalents and variations that are within the spirit and scope of the disclosed subject.

### Step 5

Take the pressing frame. Open it carefully.

Take the bottom of the frame and place it under the sheet of paper on which the painting is located.

### Step 6

Take the glass and carefully place it over your painting.

### Step 7

Take the frame and place on top of the glass that is in the picture.

### Step 8

Take the entire structure with both hands and turn it over so that the glass is at the bottom.

### Step 9

If the fibers of the wool will go outside the frame, you can trim it gently.

What is claimed is:

1. Method of manufacturing three-dimensional decorative elements from fibers of no-spun natural wool, the steps of:
creating of foundations from natural wool fibers for decorative elements using the property of natural wool to felting when exposed to water and soap;
saturating each element with polyurethane varnish;
removing any excess polyurethane varnish from the surface of each element;
giving each element the three-dimensional shape;
leaving the elements to dry completely naturally at room temperature;

2. Mounting method the steps of:
gluing at least one magnet to the surface of each element;
gluing the magnet to the surface using double-sided tape according to the number of magnets located on each individual element;
connecting of magnets on each element with a magnet on the surface;
